(19) United States
(12) Patent Application Publication
(10) Pub. No.: US 2011/0097472 A1
(43) Pub. Date: Apr. 28, 2011

(54) DAIRY PROTEIN GEL

(75) Inventors: Christina June Coker, Palmerston North (NZ); Satyendra Parshu Ram, Palmerston North (NZ); David Campbell Wemyss Reid, Palmerston North (NZ); Andrea Joy Mcleod, Palmerston North (NZ); Christine Joy Thompson, Palmerston North (NZ); Siew Kim Lee, Palmerston North (NZ)

(73) Assignee: Fonterra Co-operative Group Limited, Auckland (NZ)

(21) Appl. No.: 12/920,029

(22) PCT Filed: Mar. 2, 2009
(86) PCT No.: PCT/NZ09/00027

§ 371 Date: Jan. 10, 2011

(30) Foreign Application Priority Data
Feb. 29, 2008 (NZ) 566358

(51) Int. Cl. A23J 3/10; A23C 23/00; A23C 20/00; A23C 19/00

(52) U.S. Cl. 426/573; 426/588

(57) ABSTRACT

A method for preparing a protein gel is provided. It comprises providing a daily starting material comprising casein; adjusting the pH, if required, to a pre-selected point in the range 5.0-8.0; subjecting the material with the pre-selected pH to a cooking step; adjusting the pH of the cooked product to 3.8-7.5, preferably 4.5-7.5; processing and/or packing the pH 3.8-7.5, preferably pH 4.5-7.5 product to form the final product or ingredient wherein at least 10% of the casein of the dairy starting material comprises alphas enriched casein having an alphas to beta casein weight ratio of greater than 1.25:1 or alphas depleted casein having an alphas to beta casein weight ratio of less than 0.8:1. The invention also provides an ingredient for use in the method.

### TECHNICAL FIELD

The present invention relates to processes for preparing dairy products and products produced. The processes involve manipulation of the texture of dairy gels using a selection of protein components and pH, shear and temperature adjustment.

### BACKGROUND

A longstanding problem with the production of cheese and cheese-like products, including processed cheese is that the ability to vary the texture of the product is often relatively limited. This is particularly a problem where an all-dairy recipe is used or when a specified fat or protein content is required.

The texture of foods is a complex combination of science and art. The literature and art disclose many ways of manipulating the texture of cheese and cheese-like products. Texture in this context relates to instrumental/rheological methods used to determine stress-strain relationships and/or particular melt characteristics at defined temperatures and/or deformation rates and fracture behaviour at defined temperatures and deformation rates. The texture of food products may also be evaluated by consumers or by using trained taste panelists by describing the mouth-feel attributes of the mastication process. The texture of foods may be manipulated over a wide range by a wide variety of methods, including but not limited to moisture content, fat content and composition, acidity, polymer structure, particle size, incorporation of multiple phases, shear rate and temperature.

Many manufacturers have adopted the practice of incorporating non-dairy ingredients into their products in an attempt to increase product firmness while reducing the protein content. The non-dairy ingredients most widely used in this role are gel-forming polysaccharides such as hydrocolloids and gums. This often necessitates labelling the products as “analogue” or “imitation” and the price has to be discounted to match consumer expectation. Being able to use an all dairy composition offers distinct nutritional advantages not possible with the cheaper imitation products

In an attempt to manipulate textures of cheese-like products in all-dairy recipes a number of approaches have been used. These include manipulation of moisture, fat, incorporation of whey proteins, microparticulation, use of the enzyme transglutaminase, use of salts and pH variation. Where the dairy ingredients are treated to alter their effect on texture, these ingredients are often known as functionalised ingredients. They allow a manufacturer a wider range of textures than can be obtained by using only standard ingredients.

U.S. Pat. No. 6,303,160 discloses a process whereby the texture of cream cheese was able to be significantly varied by controlling the incorporation of water at key stages of the manufacturing process.

U.S. Pat. No. 3,929,892 discloses a method whereby fat in cream cheese is replaced using a mixture incorporating heat denatured whey proteins and caseins. The heat denaturated protein is mixed with cheese curd, acidified to attain the final pH required and then homogenised and packed.

Various methods have been disclosed using ultrafiltration to concentrate milk to produce a variety of cheese and cheese-like products. The basis of these processes is to increase product yield by the incorporation of whey proteins. A distinguishing attribute of these processes is that the final whey protein/casein ratio is similar to that of the parent milk entering the ultrafiltration process. Such processes include those of U.S. Pat. Nos. 5,356,639 and 4,341,801. There is little scope to independently manipulate the texture of the product by varying the incorporation of whey protein to a desired level.

Alternative approaches include adding whey proteins to a cheese curd. U.S. Pat. No. 6,558,716 discloses a process that incorporates whey protein into cheese that is claimed to enhance functionality and reduce production costs. A cheese curd is produced by essentially conventional means. Whey protein (via a concentrate or powder) is added to the curd, then the mixture is homogenised and subject to heat treatment and shear. US Patent application 20020192348 discloses a process that attempts to build on U.S. Pat. No. 6,558,716 by including the use of modified proteins, particularly modified whey protein ingredients in the preparation of processed cheese.

Another technique used for producing dairy-based gels of varying texture involves controlled denaturation of soluble proteins, specifically the controlled denaturation of whey proteins (egg proteins may also be used). Distinguishing attributes of these processes are heat treatment, pH adjustment and homogenisation steps so that the protein particles emerge with a carefully controlled particle size distribution (typically <10 μm) i.e. micro particulation. See for instance EP patent application 1,201,134 and PCT published application WO 91/17665 describing formation of microparticulated denatured whey proteins.

Löv & Löv (WO 98/08396) extend this process to the micro particulation of denatured casein-whey protein aggregates.

A further method of incorporating whey proteins into cheese and cheese-like products is to enzymatically crosslink the whey and casein proteins using an enzyme such as transglutaminase.

Processes where salt interactions are used include that of U.S. Pat. No. 4,166,142. This describes a method of preparing processed cheese where whey protein was denatured in conjunction with salts of phosphate and citrate along with the usual processed cheese ingredients including blends of young and old cheese.

NZ Patent 254127 discloses a process where salts of phosphate and citrate in conjunction with pH and heat modifies whey protein concentrate solutions, that are then dried and used as an ingredient in process cheese manufacture. The incorporated whey protein enables a significant reduction in cheese requirements in the process cheese formulation.

Modler & Emmons in International Dairy Journal 11,517-523 (2001) observed that‘ . . . native whey proteins, from whey protein concentrate (WPC) for example, tend to aggregate when heated in acidic conditions in the presence of casein and this can lead to grittiness in the finished products: this is probably due to the strong interaction between β-lactoglobulin and κ-casein. The formation of firm aggregated protein particles does not occur to the same extent in the continuous process primarily because the denaturation step occurs at a higher pH (e.g. 6.8-7.0)'. Modler & Emmons describe a continuous process for the production of ricotta and Queso Blanco cheese using whey or a mixture of whey and milk. Up to 5% skim milk powder may be added to the mixture. The thermal denaturation of the proteins is conducted at a pH range of 6.8-7.0 to minimise protein deposition on the heat exchanger surfaces. After heat treatment, the mixture is acidified to pH 5.4-5.6 and allowed to coagulate while still hot before draining and packing.

The Modler & Emmons process is directed towards a continuous process using whey or mixtures of whey and milk that may be fortified with skim milk powder to produce ricotta and they speculate that it has the ‘potential to produce casein, Paneer and Queso Blanco’. Their process requires a curd draining step and does not produce processed cheese directly, if at all. The Modler & Emmons process does not use melting salts and related agents to sequester calcium.

In WO 02/096209, Renault et al. disclose a process for preparing a cheese base using a two-stage acidification process. The pH is reduced initially by fermentation to 5.6-5.9 and then by direct acid addition to pH 5.2-5.5. The objective of this treatment is to manipulate the product calcium concentration.

A variety of cheeses and cheese products may be made by acidifying milk or milk protein concentrates to acid pHs (generally in the range 4-6) and heating to produce cheese. For example such processes are described in U.S. Pat. Nos. 5,356,639 and 6,177,118, and US published patent application 2005/0123647. Some of these processes have no whey separation step, whereas others involve separation of resulting curds from whey. Coagulation enzymes are used in some of the processes, but generally these processes avoid coagulation before heating to form cheese.

WO2005/002350 discloses that the texture of cheese, cheese-like products and related products can be varied over a surprisingly wide range by varying the casein to whey protein ratio while controlling the cooking pH in the range 5.0 to 8.0 preferably 5.8-7.5, more preferably 6.0-7.0, most preferably 6.3-7.0.

Once the controlled interaction of the proteins has occurred during the cooking period, the final product pH may be attained by adding acid (or alkali) to achieve typically a pH of 4.5-7.5 preferably 5.0-6.3, more preferably 5.0-6.0.

Whole casein and caseinate consist of four primary proteins—alphaₛ₁-casein, alphaₛ₂-casein, beta-casein and kappa-casein. Each of these components has a unique composition and structure.

The approximate content of the four proteins in casein/caseinate products (% by weight) is 36-40, 10-12, 33-40 and 10-12 for alphaₛ₁-, alphaₛ₂-, beta- and kappa-casein respectively.

Alphaₛ₁-casein and alphaₛ₂-casein are the products of two different genes. In this specification the term alphaₛ-casein refers to a mixture of the two proteins.

U.S. Pat. No. 5,068,118 indicates that alphaₛ₁-casein provided a simulated process cheese with melt properties close to that of sodium caseinate cheese but with a small improvement in texture. This patent also indicates that beta-casein provided a simulated process cheese which was soft and had restricted melt properties.

Any discussion of documents, acts, materials, devices, articles or the like that has been included in the present specification is solely for the purpose of providing a context for the present invention. It is not to be taken as an admission that any or all of these matters form part of the prior art base or were common general knowledge in the field relevant to the present invention as it existed before the priority date.

It is an object of the present invention to provide a method for preparing a dairy product with manipulated texture, using an effective functional ingredient, or at least to provide the public with a useful choice.

### DISCLOSURE OF THE INVENTION

In one aspect the invention provides a method for preparing a protein gel or a dairy protein gel ingredient comprising:
(a) providing a dairy starting material comprising casein;
(b) adjusting the pH, if required, to a pre-selected point in the range 5.0-8.0;
(c) subjecting the material with the pre-selected pH to a cooking step;
(d) adjusting the pH of the cooked product to 3.8-7.5, preferably 4.5-7.5;
(e) processing and/or packing the pH 3.8-7.5, preferably pH 4.5-7.5 product to form the final product or ingredient
   wherein at least 10% of the casein of the dairy starting material comprises alpha, enriched casein having an alpha, to beta casein weight ratio of greater than 1.25:1 or alpha, depleted casein having an alpha, to beta casein weight ratio of less than 0.8:1.

Preferably the dairy starting material comprises whey protein, preferably undenatured whey protein. Preferably the product is a cheese, a processed cheese, a cream cheese, a cheese-like product, a yoghurt or a dairy dessert.

In one embodiment the product is a processed cheese, prepared from a cheese prepared by the above method. In a further embodiment, cheese without alpha, casein enrichment/depletion is combined with an alpha, enriched or depleted casein source for use in the method. Alternatively, the product is a dairy protein gel ingredient.

To produce a cream cheese, the ingredients are selected to include a high dairy fat content, typically over 30% (w/w). For a yoghurt, the heat-treated material is generally acidified using yoghurt forming bacteria, for example, Lactobacillus bulgaricus and Streptococcus themophilus.

The dairy starting material may include any type of dairy product containing both casein and whey proteins. In addition to alpha, enriched or alpha, depleted casein, suitable materials for use in the starting product include cheese, rennet casein, lactic or acid casein, skim milk, whole milk, milk protein concentrates and mixtures of any of these. Also suitable are mixtures of a casein source and a whey protein source, for example, a mixture of whey protein concentrate and casein.

Preferably the process does not include a whey removal step. However, where the starting material is not in a concentrated form, it may be necessary to use a whey removal step. This would, for example, be necessary for a process based on that of US patent application 2005/0123647 with cooking of acidified skim milk along a flow path and subsequent separation of coagulated curd particles from whey.

Preferably the dairy starting material comprises alpha, enriched casein when the product is a cheese, a cheese-like product or a cream cheese. When the product is a yoghurt, an alpha, depleted fraction is preferred. However, in each case the less preferred fraction may be used if reduced firmness is required. Preferably at least 15% of the casein in the starting material is alpha, enriched casein or alpha, depleted casein, more preferably at least 20%, most preferably at least 25%.

The ratio of whey protein to casein may be varied within the range of 0-3, preferably 0.05-3, more preferably 0.1 to 1.5, most preferably 0.1-0.75.

The preferred casein concentration is in the range 1-30% (w/w), more preferably 3-20% (w/w). Concentrations in the range 5-15% (w/w) are particularly preferred.

In a preferred embodiment, the invention provides a process for preparing a cheese, a cheese-like product, a yoghurt or a dairy dessert comprising:
(a) providing a dairy starting material comprising casein and preferably a quantity of whey protein;
(b) adjusting the pH, if required, to a preselected point in the range 5.0-8.0;
(c) subjecting the material with the desired pH to a cooking step;
(d) adjusting the pH of the cooked product to 4.5-7.5 while liquid;
(e) placing the pH 4.5-7.5 product into packaging while still liquid; and
(f) providing conditions which allow the packaged product to set;
   wherein at least 10% of the casein comprises alpha, enriched casein.

The term “cheese-like product” is a product which on being consumed by consumer imparts the sensation of consuming cheese. The products of the process include processed cheese and processed cheese spread, cottage cheese, analogue cheese and Petit Suisse. Particularly preferred products include processed cheese and processed cheese spread.

The term “comprising” means “consisting of” or “including”. The processes of the invention may have additional steps and ingredients. For example salt, flavouring, colouring etc may be added.

The term “alpha, enriched casein” is used for casein fractions with an alpha:beta ratio higher than that of skim milk (1:0.94, as measured by polyacrylamide gel electrophoresis followed by staining with Amido Black and densitometry). Preferably the ratio is higher than 1.3:1, more preferably higher than 1.6:1, more preferably higher than 2:1, most preferably higher than 3:1. Alpha, enriched casein is enriched in at least alphaₛ₁ or alphaₛ₂ casein, generally both, relative to casein in the casein source from which it was prepared (generally cows' milk).

The teen “alpha, depleted casein” is used for casein fractions with an alpha:beta ratio lower than 1:0.94. Preferably, the ratio is lower than 0.8:1, more preferably lower than 0.7:1, more preferably lower than 0.5:1, most preferably less than 0.3:1. Alpha, depleted casein is depleted in at least alphaₛ₁ casein relative to casein in the casein source from which it was prepared (generally cow's milk).

Alphaₛ enriched and depleted casein fractions can be prepared as described in published PCT application WO2007/100246 (hereby incorporated by reference in its entirety). Other methods may be used. For example cold microfiltration may be used for at least part of the enrichment or depletion (see U.S. Pat. No. 5,169,666)

The alpha, enriched or depleted casein fraction need not be substantially purified casein. The same benefits are obtainable from casein-containing fractions containing whey proteins and fat provided that the alpha:beta ratio has been increased or decreased to the ratios used in the invention. The terms alphaₛ enriched or depleted casein fraction therefore includes milk protein concentrates comprising whey proteins. The fractions may also be in the form of rennet casein or caseinate as well as casein. The essential feature is the enrichment or depletion of alpha, casein.

The inventors have discovered that inclusion of alpha, enriched or depleted casein increases the gel strength of a dairy product relative to the corresponding product without alpha, enriched or depleted casein. The choice of cook pH further influences the gel strength. In a preferred embodiment the cook pH is selected to maximise the subsequently formed gel's strength.

The alphaₛ enriched or depleted casein fraction generally provides only 10-50% of the casein in the product, preferably 15-40%. This fraction can be a purified casein fraction or can be part of another type of fraction, as described above.

For the other casein in the product, any source of casein may be used—including but not limited to milk, casein, fresh casein curd, skim milk cheese, young cheese and milk protein concentrate powders (MPC) (retentate powders) or fresh retentate (including modified retentates and retentate powders). Ingredients containing casein that have been pre-treated with an agent to produce para casein are preferred.

The preferred cook pHs vary according to composition but are generally in the range 5.7-7.5, usually 6.2-7.2, often 6.4-7.0. Once cooking has taken place, the pH is often adjusted to 4.5-6.2, preferably 4.8-5.9. The cook pH is preferably optimised for the particular method. For alphaₛ casein in cheese slices, a pH of 6.1-6.7 is preferred, while for alpha-depleted pH 6.4-7.0 is preferred.

Preferred fats are milkfat, butter and butter oil (anhydrous milkfat), fractionated milkfats, hydrolysed milkfats, milk phospholipids, and milkfat enriched in CLA by the addition of natural or synthetic CLAs or omega fatty acids. Any ratio of fat to protein as desired may be used but ratios between zero and 200% are preferred.

When fats are used in the dairy starting material or subsequently added, shearing is preferably applied. A wide range of undenatured whey protein sources may be used depending on the desired lactose and mineral concentrations in the finished product. Dried whey protein concentrates or concentrated whey protein retentates may be used.

The process may be conducted using a mixture of fresh dairy ingredients in the liquid state and optionally fortified with the addition of dry ingredients containing either casein or whey protein containing powders.

Where the process is required to be independent of a fresh milk or fresh whey supply, dry ingredients may be used. Preferred dry ingredients include casein (including rennet casein), caseinate, cheese, MPC and whey protein concentrates.

Preferred dairy ingredients are blends of casein and whey protein containing powders, or MPC and whey protein containing powders. The casein rich powder and the whey protein rich powders may be pre-blended in a preferred ratio. Alternatively, the casein and whey protein containing powders may be combined at the point of filling the cooking device.

In another aspect, a mixture of wet and dry starting materials may be used.

Preferred cooking temperatures are in the range 50° C. and up to the boiling point of the mixture. The preferred cooking time varies according to temperature used and the nature of the starting material. Generally times in the range 1 second to 30 minutes are used. Preferred cooking times may be chosen on the basis that they are sufficient for modification of the casein whey interaction. Casein whey interactions provided by the cooking step provide increased strength of the texture of products produced from the casein whey mixture relative to uncooked controls or controls cooked at a pH of approximately 5.7.

The mixture of casein and whey protein, and any fat, is cooked with an initial pH (cooking pH) in the range pH 5.0 to 8.0. Any suitable agent may be used to attain the cooking pH. Preferably the pH adjustment either before or after the cooking step is carried out by direct addition of an alkali or acidulant. Preferred agents may be selected as allowed by Codex Alimentarius Standard 221-2001 (Codex group standard for unripened cheese including fresh cheese). This may be found at http://www.codexalimentarius.net/standard_list.asp or its updates. The acids that may be used include acetic, lactic, malic, citric, orthophosphoric and hydrochloric acids.

In a preferred embodiment, suitable monovalent cationic salts of phosphate and citrate (widely known as melting salts) may be used in conjunction with the alkali or acid. In another aspect, some of the monovalent cationic salts of phosphate and citrate added may substitute for some of the alkali or acid required. Preferred salts are widely known as melting salts and a preferred alkali is sodium hydroxide, and preferred acids are lactic acid or citric acid or a mixture of the two. In other embodiments, melting salts are not used.

Once the initial cooking step has been concluded, the acidity of the mixture may be decreased further to the final desired level by the addition of suitable food-grade acid or in the case of yoghurt by utilisation of lactose by added lactic acid bacteria. Preferred acids for this step are lactic acid, an acid precursor such as glucono-delta-lactone (GDL), citric acid and acetic acid, or the pH may be manipulated by the addition of melting salts. Any suitable ingredients such as, but not limited to, flavourings, colouring, common salt and water may also be added.

A consequence of the invention is that a wide range of ‘all dairy’ cheese products can be made with desired textures and good flavours but at lower cost. The manufacture of processed cheese, analogue cheese and processed cheese spread are preferred products. For some products such as cheese slices and cream cheese, traditional product texture characteristics such as firmness can be attained at an overall reduction in protein content. This offers the consumer the prospect of a more competitive product. Alternatively, increasing the whey protein to casein ratio may make a firmer product having the same overall protein content.

In another aspect the invention provides a method for making a dairy ingredient comprising

(a) providing a dairy starting material comprising casein and undenatured whey protein;
(b) adjusting the pH, if required, to a pre-selected point in the range 5.0-8.0;
(c) subjecting the material with the pre-selected pH to a cooking step; and
(d) drying the heat treated material to form a powder, preferably by spray drying;
wherein at least 10% of the casein of the dairy starting material comprises alpha, enriched casein having an alpha, to beta casein weight ratio of greater than 1.25:1 or alpha, depleted casein having an alpha, to beta casein weight ratio of less than 0.8:1

The preferred casein whey ratios, alpha to beta casein ratios, starting concentrations, proportions of alpha, enriched or depleted caseins, cook pHs and temperatures are as described for the other aspects of the invention. The dried ingredient is useful in a range of applications, for example manufacture of cheese, processed cheese, cheese spreads, analogue cheeses, yoghurt and the like. The ingredient can also be used for a wide variety of food gels, for example, as base for hydrolysed protein gels to release physiologically active components from milk proteins, icecream, and coffee creamers.

One advantage of the invention is that it allows the increase of firmness of gels in products comprised solely of dairy ingredients that would otherwise require addition of non-dairy gelling ingredients. However, the invention is also useful in combination with non-dairy gelling ingredients, and particularly for reducing their use. The gels of the invention are also useful in gelling in non-dairy foods.

### BRIEF DESCRIPTION OF THE DRAWINGS

Preferred embodiments of the invention will now be described with reference to the accompanying drawings.

FIG. 1 is a flow diagram showing a preferred method of the invention. The casein in the starting material includes a fraction that is an alpha, enriched or depleted casein fraction

FIG. 2 shows the firmness of processed cheese slices containing different proportions (fractions) of α₁-casein (the remainder is mainly β-casein).

FIG. 3 shows Schreiber melt score versus proportion (fraction) of αₛ-casein in the processed cheese slices (remainder is mainly β-casein).

FIG. 4 is a graph showing the effect of cook pH on firmness of processed cheese slices—whey protein 20% of total.

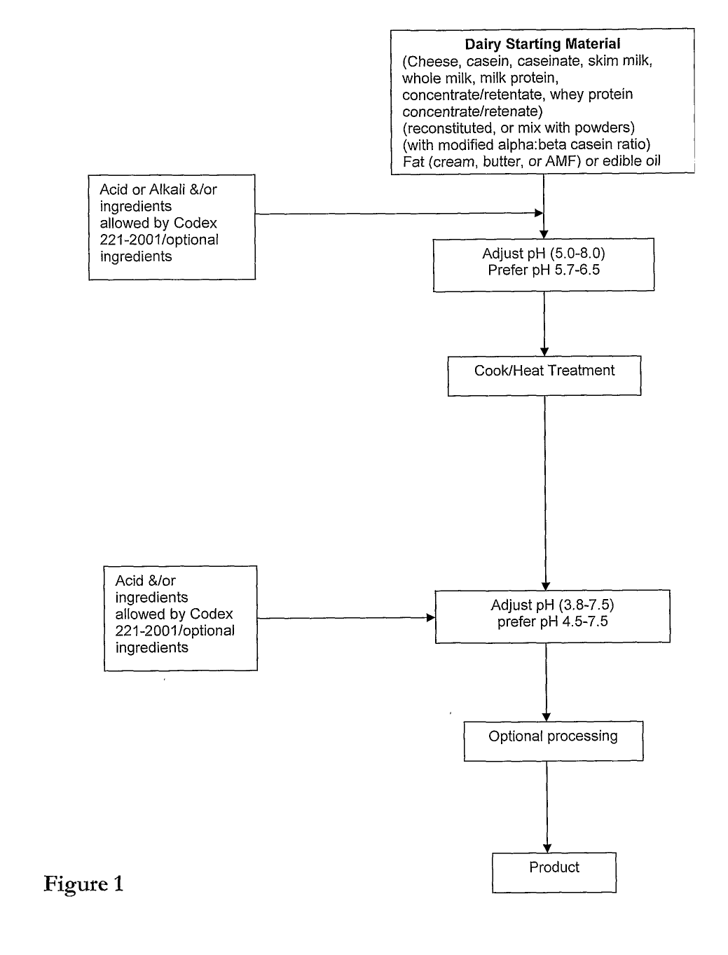

### EXAMPLES

The following examples further illustrate practice of the invention.

### Example 1

### Preparation of Casein Fractions

The casein fractions were prepared by the method described in WO 2007/100264 (fully incorporated herein by reference). 4% Lactic Casein (Fonterra Co-operative Group Limited) was adjusted to pH 10.2 by addition of 10 m NaOH. 0.1 M Calcium chloride dihydrate (0.272 g/g lactic casein) was added at a temperature of 7° C. The alphaₛ enriched fraction is the precipitate. The precipitate was suspended, acidified to pH 4.5 with HCl, held at 4° C. overnight, recovered by centrifugation and dried. The alphaₛ-deplete fraction is precipitated with HCl (to pH 4.35), acid washed and spray dried.

For the alpha casein fraction, the average protein content was 93.2%; ratio of αs-casein:β-casein is 5.9

For the alphaₛ deplete fraction beta casein fraction the average protein content is 91.3%, the ratio of β/κ-casein:αs-casein is 2.3

### Example 2

### Processed Cheese Slice Manufacture without pH Adjustment Between Denaturation and Final Product (Comparative Example)

### 2.1 Formulation

Processed cheese was prepared using the formulations of Table 1 without whey protein.

TABLE 1
Summary of formulations for processed cheese slices

| | | Lactic | | | | | |
|---|---|---|---|---|---|---|---|
| | | Casein | Maximum | 25 αₛ₁-: 75 | 50 αₛ₁-: 50 | 75 αₛ₁-: 25 | Maximum |
| Ingredient | | (Control) | β-casein | β-casein | β-casein | β-casein | αₛ₁-casein |
| Added Water | (g) | 6.700 | 6.960 | 6.860 | 6.780 | 6.680 | 6.600 |
| NaOH | (g) | 2.660 | 2.500 | 2.550 | 2.600 | 2.640 | 2.690 |
| Lactose | (g) | 0.490 | 0.210 | 0.200 | 0.200 | 0.200 | 0.265 |
| TSC | (g) | 0.880 | 0.880 | 0.880 | 0.880 | 0.880 | 0.880 |
| Salt | (g) | 0.290 | 0.300 | 0.300 | 0.300 | 0.300 | 0.290 |
| 175 αₛ-casein | (g) | 0.000 | 0.000 | 0.850 | 1.680 | 2.550 | 3.395 |
| 863 β-casein | (g) | 0.000 | 3.180 | 2.390 | 1.590 | 0.780 | 0.000 |
| Lactic Casein | (g) | 3.100 | 0.000 | 0.000 | 0.000 | 0.000 | 0.000 |
| Cheddar 600 | (g) | 1.400 | 9.400 | 7.100 | 5.600 | 3.000 | 1.000 |
| Mature Cheddar | (g) | 9.200 | 1.200 | 3.500 | 5.000 | 7.600 | 9.600 |
| Butter | (g) | 5.100 | 5.190 | 5.190 | 5.190 | 5.190 | 5.100 |
| Citric Acid | (g) | 0.120 | 0.120 | 0.120 | 0.120 | 0.120 | 0.120 |
| Sorbic Acid | (g) | 0.060 | 0.060 | 0.060 | 0.060 | 0.060 | 0.060 |
| TOTAL | (g) | 30.000 | 30.000 | 30.000 | 30.000 | 30.000 | 30.000 |

Processed cheese was prepared using the formulations of Table 1 without whey protein.

### 2.2 Method

Water, NaOH, lactose, trisodium citrate (TSC) and salt were weighed, then mixed together in a plastic container. The casein powder was added and mixed. The mixture was then left to hydrate for 40 minutes. The hydration target pH was 7.5-7.6.

The cheeses (young Cheddar and mature Cheddar) and butter were weighed directly into the plastic container used for the hydration. The citric acid and sorbate were weighed, and then added to the other ingredients in the plastic container. All the ingredients in the plastic container were mixed together.

An aluminium canister was tared on a balance, and then the cheese mixture was put inside. All the scrapings from the plastic container and spatulas were added to get the transfer weight of the mixture as close as possible to 30 g (at least 29.5 g). A plastic stirring blade was placed in the aluminium canister, and then the canister was put onto the RVA.

The RVA temperature speed profile used was the PC Alan method (800 rpm). The temperature was increased linearly from 20° C. to 85° C. over 4 minutes, and then held at 85° C. for 6 minutes. The stirring speed was increased stepwise from 0 rpm to 200 rpm over 3 minutes, and then increased to 800 rpm for the next 7 minutes.

The hot processed cheese from the RVA was poured from the canister onto a plastic strip cut to the appropriate size of a cheese slice. Another plastic strip was placed on top. The cheese was then rolled to 2.5 mm thickness using a rolling pin and guides.

The slices were labelled and placed onto a metal tray in the refrigerator (temperature 4° C.). The processed cheese slices were stored at 4° C. until the slices were tested at seven days.

### 2.3 Results

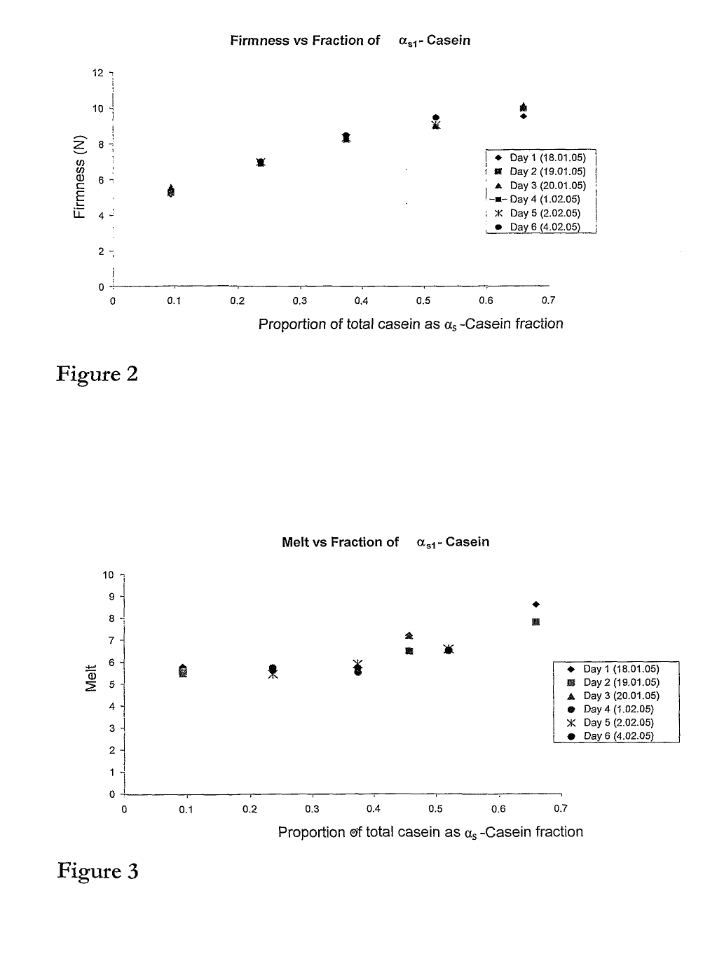

The results show that the firmness of the cheese slices increased as the proportion of alphaₛ₁-casein increased from 0.1 to 0.7. Similar results were found for melt. (See FIGS. 2 and 3)

### Example 3

### Processed Cheese Spreads—Effect of Cook pH

Use of the alphaₛ casein fraction and alphaₛ depleted casein fraction (referred to as Beta-casein fraction) in a model processed cheese spread system containing rennet casein at two different whey protein to total protein ratios (20% and 35%).

### 3.1 Model Processed Cheese Spread Preparation

The preparation method for all the model processed cheese spreads is similar to the examples given below using the alphaₛ casein fraction. The recipes for those with 20% or 35% whey protein to total protein are listed in Tables 2 and 5 respectively; the amount of trisodium citrate (TSC), citric acid (CA), sodium hydroxide (NaOH) and hydrochloric acid (HCl) for the recipes are listed in Tables 3 and 6 respectively. TSC, CA, NaOH and HCl are used for adjusting the cook pH of the processed cheese spread.

### 3.2 Model Processed Cheese Spread Preparation Using Alphaₛ Casein Fraction at a Cook pH of 5.7

The model processed cheeses were prepared using a 2 L capacity Vorwerk Thermomix™ 21 blender cooker (Vorwerk Australia Pty. Ltd., Granville, N.S.W., Australia). The recipe is as detailed in Table 2.

The required amount of rennet casein (ALAREN 799, 90 mesh, Fonterra, New Zealand) and alphaₛ casein fraction (30 mesh all in (“all in” means that it includes all powder particles less than 600 μm in diameter, prepared as described in Example 1). was hydrated in salt solution (include 12.969 g trisodium citrate (Jungbunzlauer GmbH, Perhofen, Austria), 2.041 g of citric acid (Jungbunzlauer GmbH, Perhofen, Austria) and 6 g sodium chloride (Pacific salt, Christchurch, New Zealand) and 150 g water). The mixture was hydrated overnight at 4° C. This provides a cook pH of 5.70. The predetermined amount of trisodium citrate and citric acid for the different cook pH is shown in Table 3c.

Soya oil (AMCO, Blue Bird Foods Ltd, Auckland, New Zealand) was heated to 60° C.

The hydrated alphaₛ casein and WPC (whey protein concentrate, Alacen 392, Fonterra dispersed in 50 g water). Then water (79.7 g) was added to the oil. The mixture was cooked at a 90° C. for 2 min at speed 4 (2000 rpm), after which the temperature was lowered to 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. 20 g of water was added at the end of the holding time. The mixture was then cooked for a further 2 min with 3 s “turbo” every minute. The total cooking time was 10 min. The molten processed cheese was poured into plastic screwed cap containers, inverted then stored at 4° C. The final pH of the processed cheese spread was 5.7.

### 3.3 Model Processed Cheese Spread Preparation Using Alphaₛ Casein Fraction at a Cook pH of 7.2

The model processed cheese spreads were prepared using a 2 L capacity Vorwerk Thermomix™ 21 blender cooker (Vorwerk Australia Pty. Ltd., Granville, N.S.W., Australia). The recipe is as detailed in Table 2.

The required amount of rennet casein (ALAREN 799, 90 mesh, Fonterra, New Zealand) and alpha, casein fraction (prepared as described in Example 1) was hydrated in salt solution (12.969 g trisodium citrate (Jungbunzlauer GmbH, Perhofen, Austria), and 6 g sodium chloride (Pacific salt, Christchurch, New Zealand) and 150 g water). The mixture was hydrated overnight at 4° C. The amounts of trisodium citrate and citric acid requited to achieve the different cook pHs are detailed in Table 3c.

Soya oil (AMCO, Blue Bird Foods Ltd, Auckland, New Zealand) was heated to 60° C.

The hydrated caseins, WPC (dispersed in 50 g water), 3.052 mL 3M NaOH (Table 3c) and water (79.7 g) were added to the oil. The mixture was cooked at 90° C. for 2 min at speed 4 (2000 rpm), after which the temperature was lowered to 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. 2.48 mL of 3M HCl and 2.041 g of citric acid dissolved in 20 g water was added at the end of the holding time. The mixture was then cooked for a further 2 min with 3 s “turbo” every minute. The total cooking time was 10 min. The molten processed cheese was poured into plastic screw cap containers, inverted and then stored at 4° C. The final pH of the processed cheese spread was 5.7.

Note: The water associated with the added NaOH and HCl was subtracted from the added water to obtain the required moisture content of the processed cheese.

### 3.4 Model Processed Cheese Spread Preparation for all Caseins at Different Cooked pHs

All model processed cheese spreads are prepared using similar preparation methods to those shown in the two methods described above. The amounts of trisodium citrate, citric acid, NaOH and HCl required to achieve the different cook pHs are shown in Table 3.

### 3.5 Composition and Properties of the Model Processed Cheese Spread

All the processed cheese spreads had been formulated to contain 52.05% moisture, 33.56% fat, 10.01% protein, 0.16% lactose and remainder 4.28% minerals and others. The firmness of the samples is shown in Table 4.

The firmness results are shown in Table 4 and in Table 7 for samples containing 20% or 35% whey protein to total protein.

The results show that both whey protein to total protein ratios (20% and 35%) using a cook pH in the range 6.2-7.2 gave increased firmness of the cheese spread relative to a cook pH of 5.7. The firmness values were higher when alpha, casein was present in the mixture.

TABLE 2
Recipe for model processed cheese spreads made using rennet,
lactic, alphaₛ casein fraction and beta casein fractions.
Whey protein to total protein ratio at 20%.

| | | | Alphaₛ | Beta |
|---|---|---|---|---|
| | Rennet | Lactic | casein | casein |
| Ingredients | casein | casein | fraction | fraction |
| Soya oil | 190.0 | 191.0 | 191.1 | 191.0 |
| Rennet casein | 54.9 | 36.4 | 36.45 | 36.5 |
| Lactic casein | 0 | 17.3 | 0 | 0 |
| Alphaₛ casein | 0 | 0 | 16.65 | 0 |
| fraction | | | | |
| Beta casein | 0 | 0 | 0 | 16.5 |
| fraction | | | | |
| WPC | 14.19 | 14.19 | 14.19 | 14.19 |
| (Alacen 392) | | | | |
| Water | 299.0 | 299.2 | 299.7 | 299.9 |
| Sodium | 6.0 | 6.0 | 6.0 | 6.0 |
| chloride | | | | |
| Trisodium | 11.687 | 13.074 | 13.060 | 12.969 |
| citrate | | | | |
| Citric acid | 3.323 | 1.936 | 1.950 | 2.041 |
| Total | 579.1 | 579.1 | 579.1 | 579.1 |

Note:
weight of water includes allowance of 6.9 g for evaporation

TABLE 3
Amount of trisodium citrate (TSC), citric acid (CA), NaOH and
HCl required to achieved different cook pH (columns 2 and
3) and to achieve final sample pH of 5.75 (columns 4
and 5) for model processed cheese at 20% whey
protein to total protein and containing:

| | | | | | |
|---|---|---|---|---|---|
| | | | NaOH | CA at | HCl (3M) |
| | TSC | CA | (3M) | the end | at the end |
| | during | during | during | of hold- | of hold- |
| Cook | cooking | cooking | cooking | ing time | ing time |
| pH | (g) | (g) | (mL) | (g) | (mL) |

a. rennet casein

| | | | | | |
|---|---|---|---|---|---|
| 5.70 | 11.687 | 3.323 | 0 | 0 | 0 |
| 6.1 | 11.687 | 2.162 | 0 | 1.161 | 0 |
| 6.4 | 11.687 | 1.384 | 0 | 1.939 | 0 |
| 6.7 | 11.687 | 0.7085 | 0 | 2.413 | 0 |
| 7.0 | 11.687 | 0.430 | 0 | 2.893 | 0 |

b. lactic casein

| | | | | | |
|---|---|---|---|---|---|
| 5.70 | 13.074 | 1.936 | 0 | 0 | 0 |
| 6.2 | 13.074 | 0.8774 | 0 | 1.0587 | |
| 6.7 | 13.074 | 0 | 0 | 1.936 | 0 |
| 7.2 | 13.074 | 0 | 3.204 | 1.936 | 3.051 |

c. alphaₛ casein fraction

| | | | | | |
|---|---|---|---|---|---|
| 5.70 | 13.06 | 1.950 | 0 | 0 | 0 |
| 6.2 | 13.06 | 0.7534 | 0 | 0 | 1.1966 |
| 6.7 | 13.06 | 0 | 0 | 1.950 | 0 |
| 7.2 | 13.06 | 0 | 3.30 | 1.950 | 3.40 |

d. Beta casein fraction (alphaₛ depleted fraction)

| | | | | | |
|---|---|---|---|---|---|
| 5.70 | 12.969 | 2.041 | 0 | 0 | 0 |
| 6.2 | 12.969 | 0.8774 | 0 | 1.1636 | |
| 6.7 | 12.969 | 0 | 0 | 2.041 | 0 |
| 7.2 | 12.969 | 0 | 3.052 | 2.041 | 2.48 |

TABLE 4
Firmness (G′) of model processed cheese spreads containing rennet
casein and rennet casein with lactic casein or alphaₛ casein fraction
or beta casein fraction at 20% whey protein to total protein.

| | | | Alphaₛ | Beta |
|---|---|---|---|---|
| | Rennet | Lactic | casein | casein |
| pH | casein | casein | fraction | fraction |
| 5.7 | 398.6 | 328.6, 197.4 | 1468, 1744.5 | 148.2, 143.8 |
| 6.1 | 904.7 | — | — | — |
| 6.2 | — | 456.1 | 2004 | 255.8 |
| 6.4 | 1006.8 | — | — | — |
| 6.7 | 2628 | 1410.5 | 4201.5 | 1084.0 |
| 7.0 | 773.75 | — | — | — |
| 7.2 | — | 908.45 | 2796.0 | 209.4 |

TABLE 5
Recipe for model processed cheese spreads made using rennet
casein, lactic casein, alphaₛ casein fraction and beta casein fraction.
Whey protein to total protein ratio at 35%.

| | | | Alphaₛ | Beta |
|---|---|---|---|---|
| | Rennet | Lactic | casein | casein |
| Ingredients | casein | casein | fraction | fraction |
| Soya oil | 190.0 | 190.06 | 190.06 | 190.07 |
| Rennet casein | 44.59 | 29.83 | 29.91 | 29.87 |
| Lactic casein | 0 | 14.23 | 0 | 0 |
| Alphaₛ casein | | | | |
| fraction | 0 | 0 | 13.68 | 0 |
| Beta casein | 0 | 0 | 0 | 13.53 |
| fraction | | | | |
| WPC | 25.0 | 24.4 | 24.41 | 24.42 |
| (Alacen 392) | | | | |
| Water | 298.5 | 292.57 | 293.13 | 293.2 |
| Sodium | 6.0 | 6.0 | 6.0 | 6.0 |
| chloride | | | | |
| Trisodium | 12.118 | 13.074 | 13.065 | 13.103 |
| citrate | | | | |
| Citric acid | 2.892 | 1.936 | 1.945 | 1.907 |
| Total | 579.1 | 579.1 | 579.1 | 579.1 |

Note:
weight of water includes allowance of 6.9 g for evaporation

TABLE 6
Amount of trisodium citrate (TSC), citric acid (CA), NaOH and HCl
required to achieved different cook pH (columns 2 and 3) and to achieve
final sample pH of 5.75 (columns 4 and 5) for model processed
cheese at 35% whey protein to total protein and containing:

| | | | | | |
|---|---|---|---|---|---|
| | | | | CA at the | HCl (3M) at |
| | | | NaOH (3M) | end of | the end of |
| | TSC during | CA during | during | holding time | holding time |
| Cook pH | cooking (g) | cooking (g) | cooking (mL) | (g) | (mL) |

a. rennet casein

| | | | | | |
|---|---|---|---|---|---|
| 5.70 | 12.118 | 2.892 | 0 | 0 | 0 |
| 6.1 | 12.118 | 1.85 | 0 | 1.042 | 0 |
| 6.4 | 12.118 | 1.388 | 0 | 1.504 | 0 |
| 6.7 | 12.118 | 0.6643 | 0 | 2.228 | 0 |
| 7.00 | 12.118 | 0.24 | 0 | 2.652 | 0 |
| 7.2 | 12.118 | 0.0664 | 0 | 2.826 | 0 |

b. lactic casein

| | | | | | |
|---|---|---|---|---|---|
| 5.70 | 13.074 | 1.936 | 0 | 0 | 0 |
| 6.2 | 13.074 | 1.030 | 0 | 0.906 | |
| 6.7 | 13.074 | 0.095 | 0 | 1.841 | 0 |
| 7.2 | 13.074 | 0 | 2.480 | 1.936 | 2.231 |

c. alphaₛ casein fraction

| | | | | | |
|---|---|---|---|---|---|
| 5.70 | 13.065 | 1.945 | 0 | 0 | 0 |
| 6.2 | 13.065 | 0.92 | 0 | 0 | 1.025 |
| 6.7 | 13.065 | 0 | 0 | 1.945 | 0 |
| 7.2 | 13.065 | 0 | 2.48 | 1.945 | 2.23 |

d. Beta casein fraction (alphaₛ-depleted fraction)

| | | | | | |
|---|---|---|---|---|---|
| 5.70 | 13.103 | 1.907 | 0 | 0 | 0 |
| 6.2 | 13.103 | 1.011 | 0 | 0.896 | |
| 6.7 | 13.103 | 0.143 | 0 | 1.764 | 0 |
| 7.2 | 13.103 | 0 | 2.155 | 1.907 | 2.022 |

TABLE 7
Firmness of model processed cheese spreads containing rennet
casein and rennet casein with lactic casein or alphaₛ casein
fraction or beta casein fraction at 35% whey protein to total protein.

| | | | Alphaₛ casein | Beta casein |
|---|---|---|---|---|
| pH | Rennet casein | Lactic casein | fraction | fraction |
| 5.7 | 450.9 | 161.8 | 1397 | 47.1 |
| 6.1 | 860.5 | — | — | — |
| 6.2 | — | 477.4 | 6569 | 141.9 |
| 6.4 | 1420.3 | — | — | — |
| 6.7 | 2441 | 2059 | 6830 | 1682 |
| 7.0 | 2029.5 | — | — | — |
| 7.2 | 1343.5 | 2536.7 | 4122 | 2271 |

### Example 4

### Processed Cheese Slices

Use of the alpha, casein fraction and alpha, depleted casein fraction (referred to as beta-casein fraction) in a model processed cheese slice system containing rennet casein at two different whey protein to total protein ratios (20% and 35%).

### 4.1 Formulations and Methods

Processed cheese slices containing different casein fractions (alphaₛ casein fraction or beta casein fractions) compared to those of made from rennet casein or lactic casein. The whey protein is ALACEN 392. The whey protein made up 20% of the total protein.

### Formulations:

The formulations are set out in Table 8.

TABLE 8
Recipe for model processed cheese slices made using rennet, lactic,
alphaₛ casein fraction and beta casein fractions.

| | Rennet | Lactic | Alphaₛ casein | Beta casein |
|---|---|---|---|---|
| Ingredients | casein | casein | fraction | fraction |
| AMF | 7.70 | 7.75 | 7.75 | 7.75 |
| Rennet casein | 4.624 | 3.113 | 3.072 | 3.113 |
| Lactic casein | 0 | 1.450 | 0 | 0 |
| Alphaₛ casein | 0 | 0 | 1.433 | 0 |
| fraction | | | | |
| Beta casein fraction | 0 | 0 | 0 | 1.470 |
| WPC (Alacen 392) | 1.175 | 1.175 | 1.175 | 1.175 |
| Water | 14.479 | 14.490 | 14.548 | 14.470 |
| Sodium chloride | 0.541 | 0.541 | 0.541 | 0.541 |
| Trisodium citrate | 0.670 | 0.771 | 0.771 | 0.776 |
| Citric acid | 0.260 | 0.159 | 0.159 | 0.154 |
| Potassium sorbate | 0.017 | 0.017 | 0.017 | 0.017 |
| Lactose | 0.534 | 0.534 | 0.534 | 0.534 |
| Total | 30 | 30 | 30 | 30 |

Table 9a, 9b, 9c, 9d shows the amount of trisodium citrate (TSC), citric acid (CA), NaOH and HCl required to achieved different cook pH (columns 2 and 3) and to achieve final sample pH of 5.75 (columns 4 and 5) for model processed cheese at 20% whey protein to total protein and containing. The water associated with the sodium hydroxide (NaOH) and hydrochloric acid (HCl) were subtracted from the total water input.

TABLE 9

| | | | | | |
|---|---|---|---|---|---|
| | | CA | | CA at the | HCl (3M) at |
| | | during | NaOH (3M) | end of | the end of |
| Cook | TSC during | cooking | during | holding time | holding time |
| pH | cooking (g) | (g) | cooking (μL) | (g) | (μL) |

a. rennet casein

| | | | | | |
|---|---|---|---|---|---|
| 5.70 | 0.670 | 0.260 | 0 | 0 | 0 |
| 6.2 | 0.670 | 0.108 | 0 | 0.152 | 0 |
| 6.7 | 0.670 | 0 | 0 | 0.260 | 0 |
| 7.2 | 0.670 | 0 | 55 | 0.260 | 40 |

b. lactic casein

| | | | | | |
|---|---|---|---|---|---|
| 5.70 | 0.771 | 0.159 | 0 | 0 | 0 |
| 6.2 | 0.771 | 0.063 | 0 | 0.096 | 0 |
| 6.7 | 0.771 | 0 | 132 | 0.159 | 125 |
| 7.2 | 0.771 | 0 | 330 | 0.159 | 310 |

c. alphaₛ casein fraction.

| | | | | | |
|---|---|---|---|---|---|
| 5.70 | 0.771 | 0.159 | 0 | 0 | 0 |
| 6.2 | 0.771 | 0.068 | 0 | 0.091 | 0 |
| 6.7 | 0.771 | 0 | 160 | 0.159 | 130 |
| 7.2 | 0.771 | 0 | 362 | 0.159 | 340 |

d. Beta casein fraction (alphaₛ depleted fraction)

| | | | | | |
|---|---|---|---|---|---|
| 5.70 | 0.776 | 0.154 | 0 | 0 | 0 |
| 6.2 | 0.776 | 0.048 | 0 | 0.106 | 0 |
| 6.7 | 0.776 | 0 | 132 | 0.154 | 122 |
| 7.2 | 0.776 | 0 | 317 | 0.154 | 295 |

### Method:

The model processed cheeses were prepared using an RVA mixture cooker (Newport Scientific, Warriewood, NSW, Australia). The recipe is as detailed in the tables below. Three casein fractions were studied in a system where ratio of rennet casein to casein fraction was 2:1. 4 cook pH levels were carried out (pH 5.7, 6.2, 6.7 and 7.2).

### For Rennet Casein Only Sample, pH 57:

4.624 g of rennet casein (ALAREN 799, 90 mesh, Fonterra Co-operative Group Limited, Auckland, New Zealand) was hydrated in with 0.67 g tri-sodium citrate Jungbunzlauer GmbH, Perhofen, Austria), 0.541 g sodium chloride (Pacific salt, Christchurch, New Zealand), 1.175 g ALACEN 392 (Fonterra, Auckland, New Zealand) and 14.479 g water in the aluminium cup for 40 min. 0.26 g citric acid Jungbunzlauer GmbH, Perhofen, Austria), 0.541 g lactose (Fonterra Co-operative Group Limited, New Zealand), 0.017 g potassium sorbate were added to the hydrated mixture and stirred. 7.70 g melted AMF (anhydrous milk fat, Fonterra Co-operative Group Limited, Auckland, New Zealand) was then added and stirred to form a coarse emulsion. The mixture was cooked using the following programme:

| Time (min) | Temp (° C.) | Speed (rpm) |
|---|---|---|
| 0 (Start) | 25 | 100 |
| 1 | 25 | 300 |
| 2 | 25 | 900 |
| 3 | 25 | 1200 |
| 4 | 85 | 1500 |
| 8 | 85 | 1500 |

Stop and add acid(s) if required

| | | |
|---|---|---|
| 10 (End) | 85 | 1500 |

At the end of the 8th min cook time, the programme stopped to allow acid to be added if required, but in this case, no acid need to be added. Cooking resumed for another 2 min. The total cooking time was 10 min. The molten processed cheese was poured onto a plastic sheet, another plastic sheet was placed over the molten mass, and then rolled to a thickness of about 2.5 mm thick (using a metal guide) and placed on a cooled metal tray in a refrigerator at 5° C.

### For Alphaₛ Casein Fraction Sample, pH 7.2:

3.072 g of rennet casein (ALAREN 799, 90 mesh, Fonterra Co-operative Group Limited, Auckland, New Zealand), 3.072 g alphaₛ casein fraction were hydrated in with 0.771 g tri-sodium citrate Jungbunzlauer GmbH, Perhofen, Austria), 0.541 g sodium chloride (Pacific salt, Christchurch, New Zealand), 1.175 g ALACEN 392 (Fonterra, Auckland, New Zealand) and 14.470 g water in the aluminium cup for 40 min. 0.541 g lactose (Fonterra Co-operative Group Limited, New Zealand), 0.017 g potassium sorbate and 362 μL of 3M NaOH were added to the hydrated mixture and stirred. 7.75 g melted AMF (anhydrous milk fat, Fonterra Co-operative Group Limited, Auckland, New Zealand) was then added and stirred to form a coarse emulsion. The mixture was cooked using the programme detailed above (for rennet casein pH 5.7 sample). At the end of the 8^{th} min, 0.159 g citric acid (Jungbunzlauer GmbH, Perhofen, Austria), and 340 μL of 3M HCl were added, the cooking resumed for another 2 min. The molten sample was then cast into slice as in the example above.

Composition of the slices: 50.3% moisture, 16.1% protein (20% whey protein), 26.1% fat, 2.0% lactose, 2.7% melting salts, 1.8% sodium chloride and 1% other salts and minerals.

### Schreiber Melt Test

The melt was determined using a modified Schreiber melt test. Details of the Schreiber melt test may be found in U.S. Pat. No. 5,750,177 which is incorporated herein by reference. The oven temperature was 170° C. and the film of cheese was 4.5-5 mm thick (2 layers of the above slices). Samples were placed in the oven and heated for 10 minutes.

### Texture Analysis

Texture was measured by the force [in Newtons] required to drive a 6 mm diameter cylinder probe at constant speed into a stack of 4 sheets of cheese (each approx. 2.5 mm thick) using a texture analyzer TA-XT2 (Stable Micro Systems, Ltd in Godalming, Surrey UK) with the following instrument settings:

Pre speed 1.0 mm/s,
Test speed 1.0 mm/s,
Post speed 1.0 mm/s,
Rupture test distance 1.00 mm,

### Distance 10.0 mm,

### Force 0.1N

### Count 5,

### Time 5.0 s

Load cell 50 kg

### Temperature 13° C.,

Trigger: auto.

The results for texture and melt tests are shown in Table 10.

TABLE 10
Texture and modified Schreiber melt results

| | Rennet casein | | Lactic casein | | Alphaₛ casein fraction | | Beta casein fraction | |
|---|---|---|---|---|---|---|---|---|
| | Firmness | Schreiber | Firmness | Schreiber | Firmness | Schreiber | Firmness | Schreiber |
| Cook pH | (N) | Melt | (N) | Melt | (N) | Melt | (N) | Melt |
| 5.7 | 5.27 | 3.4 | 5.44 | 2.6 | 5.92 | 3.0 | 5.57 | 2.0 |
| 6.2 | 6.04 | 5.8 | 6.05 | 2.9 | 7.23 | 2.0 | 5.72 | 4.1 |
| 6.7 | 6.61 | 6.5 | 6.15 | 7.4 | 7.14 | 1.3 | 5.50 | 6.0 |
| 7.2 | 6.10 | 6.3 | 5.46 | 7.4 | 6.97 | 0.8 | 5.02 | 4.8 |

### 4.2 Use of Partially Denatured WPC in Processed Cheese Slice Containing Alphaₛ Casein Fraction.

Processed cheese slices containing alphaₛ casein fraction and rennet casein (ratio of 1:2) and whey protein concentrates (partially denatured WPC) were made at 4 different cook pH values (5.7, 6.2, 6.7 and 7.2) (see Tables 11 and 12). A corresponding series of slices containing only rennet casein samples were also made as the controls. The texture and melt test results are shown in Table 13.

The methods of making the slices and the analyses were similar to those in 1. Partially denatured WPC was used in the formulation as the source of whey proteins. The whey protein made up 20% of the total protein in the formulation.

TABLE 11
Recipe for model processed cheese slices made using rennet
and alpha casein fraction and partially denatured WPC

| | | Alphaₛ casein |
|---|---|---|
| Ingredients | Rennet casein | fraction |
| AMF | 7.70 | 7.803 |
| Rennet casein | 4.624 | 3.084 |
| Alphaₛ casein | 0 | 1.387 |
| fraction | | |
| Partially denatured | 1.167 | 1.167 |
| WPC | | |
| Water | 14.487 | 14.537 |
| Sodium chloride | 0.541 | 0.541 |
| Trisodium citrate | 0.670 | 0.771 |
| Citric acid | 0.260 | 0.159 |
| Potassium sorbate | 0.017 | 0.017 |
| Lactose | 0.534 | 0.534 |
| Total | 30 | 30 |

Table 12 (a) and 12 (b). Amount of trisodium citrate (TSC), citric acid (CA), NaOH and HCl required to achieved different cook pH (columns 2 and 3) and to achieve final sample pH of 5.75 (columns 4 and 5) for model processed cheese containing partially denatured WPC. The water associated with the sodium hydroxide (NaOH) and hydrochloric acid (HCl) were subtracted from the total water input.

TABLE 12a
rennet casein

| | TSC | | | CA at the | HCl (3M) at |
|---|---|---|---|---|---|
| | during | | NaOH (3M) | end of | the end of |
| Cook | cooking | CA during | during | holding time | holding time |
| pH | (g) | cooking (g) | cooking (μL) | (g) | (μL) |
| 5.70 | 0.670 | 0.260 | 0 | 0 | 0 |
| 6.2 | 0.670 | 0.132 | 0 | 0.128 | 0 |
| 6.7 | 0.670 | 0.055 | 0 | 0.205 | 0 |
| 7.2 | 0.670 | 0.005 | 0 | 0.255 | 0 |

TABLE 12b
alphaₛ casein fraction

| | TSC | | | CA at the | HCl (3M) at |
|---|---|---|---|---|---|
| | during | | NaOH (3M) | end of | the end of |
| Cook | cooking | CA during | during | holding time | holding time |
| pH | (g) | cooking (g) | cooking (μL) | (g) | (μL) |
| 5.70 | 0.771 | 0.159 | 0 | 0 | 0 |
| 6.2 | 0.771 | 0.073 | 0 | 0.086 | 0 |
| 6.7 | 0.771 | 0 | 75 | 0.159 | 50 |
| 7.2 | 0.771 | 0 | 160 | 0.159 | 120 |

TABLE 13
Texture and modified Schreiber melt results of processed cheese
slices containing partially denatured WPC

| | |
|---|---|
| Rennet casein | Alphaₛ casein fraction |

| Cook | Firmness | Schreiber | Firmness | Schreiber |
|---|---|---|---|---|
| pH | (N) | Melt | (N) | Melt |
| 5.7 | 5.12 | 7.0 | 5.40 | 9.6 |
| 6.2 | 5.34 | 8.2 | 6.04 | 10.8 |
| 6.7 | 5.89 | 8.1 | 6.02 | 8.4 |
| 7.2 | 5.21 | 9.0 | 5.41 | 9.1 |

### 4.3 Different Protein Levels

Processed cheese slices containing alphaₛ casein fraction were compared to those of made from rennet casein at 16, 15 and 14% protein (Table 14). Ratio of alphaₛ casein fraction to rennet casein was of 1:2. The whey protein is ALACEN 392. The whey protein made up 20% of the total protein.

The methods used were similar to those in 4.1.

TABLE 14

| | Rennet casein | | | Alphaₛ casein fraction | | |
|---|---|---|---|---|---|---|
| | % protein | | | | | |
| Ingredients | 16 | 15 | 14 | 16 | 15 | 14 |
| AMF | 7.70 | 7.70 | 7.70 | 7.803 | 7.75 | 7.75 |
| Rennet casein | 4.624 | 4.323 | 4.035 | 3.084 | 2.895 | 2.702 |
| Alphaₛ casein | 0 | 0 | 0 | 1.387 | 1.307 | 1.220 |
| fraction | | | | | | |
| WPC (Alacen | 1.175 | 1.125 | 1.050 | 1.167 | 1.101 | 1.028 |
| 392) | | | | | | |
| Water | 14.479 | 14.83 | 15.193 | 14.537 | 14.914 | 15.278 |
| Sodium | 0.541 | 0.541 | 0.541 | 0.541 | 0.541 | 0.541 |
| chloride | | | | | | |
| Trisodium | 0.670 | 0.695 | 0.700 | 0.771 | 0.785 | 0.796 |
| citrate | | | | | | |
| Citric acid | 0.260 | 0.235 | 0.230 | 0.159 | 0.145 | 0.134 |
| Potassium | 0.017 | 0.017 | 0.017 | 0.017 | 0.017 | 0.017 |
| sorbate | | | | | | |
| Lactose | 0.534 | 0.534 | 0.534 | 0.534 | 0.534 | 0.534 |
| Total | 30 | 30 | 30 | 30 | 30 | 30 |

### Composition of the Slices:

14% protein:

52.4% moisture, 14.0% protein (20% whey protein), 25.9% fat, 2.0% lactose, 2.7% melting salts, 1.8% sodium chloride and 1.2% other salts and minerals.

15% protein:

51.3% moisture, 15.0% protein (20% whey protein), 26.1% fat, 2.0% lactose, 2.7% melting salts, 1.8% sodium chloride and 1.1% other salts and minerals.

16% protein:

50.3% moisture, 16.1% protein (20% whey protein), 26.1% fat, 2.0% lactose, 2.7% melting salts, 1.8% sodium chloride and 1% other salts and minerals.

Table 15 (a) and (b) shows the amount of trisodium citrate (TSC), citric acid (CA), NaOH and HCl required to achieved different cook pH (columns 2 and 3) and to achieve final sample pH of 5.75 (columns 4 and 5) for model processed cheese slices at 16, 15 and 14% total protein. The water associated with the sodium hydroxide (NaOH) and hydrochloric acid (HCl) were subtracted from the total water input.

TABLE 15

| | | | | | |
|---|---|---|---|---|---|
| | TSC | | | CA at the | HCl (3M) at |
| | during | | NaOH (3M) | end of | the end of |
| Cook | cooking | CA during | during | holding time | holding time |
| pH | (g) | cooking (g) | cooking (μL) | (g) | (μL) |

a. rennet casein.
16% protein

| | | | | | |
|---|---|---|---|---|---|
| 5.70 | 0.670 | 0.260 | 0 | 0 | 0 |
| 6.2 | 0.670 | 0.108 | 0 | 0.152 | 0 |
| 6.7 | 0.670 | 0 | 0 | 0.260 | 0 |
| 7.2 | 0.670 | 0 | 55 | 0.260 | 40 |

15% protein

| | | | | | |
|---|---|---|---|---|---|
| 5.70 | 0.695 | 0.235 | 0 | 0 | 0 |
| 6.2 | 0.695 | 0.135 | 0 | 0.100 | 0 |
| 6.7 | 0.695 | 0.047 | 0 | 0.188 | 0 |
| 7.2 | 0.695 | 0 | 15 | 0.235 | 10 |

14% protein

| | | | | | |
|---|---|---|---|---|---|
| 5.70 | 0.700 | 0.230 | 0 | 0 | 0 |
| 6.2 | 0.700 | 0.135 | 0 | 0.095 | 0 |
| 6.7 | 0.700 | 0.035 | 0 | 0.195 | 0 |
| 7.2 | No data | | | | |

b. alphaₛ casein fraction
16% protein

| | | | | | |
|---|---|---|---|---|---|
| 5.70 | 0.771 | 0.159 | 0 | 0 | 0 |
| 6.2 | 0.771 | 0.068 | 0 | 0.091 | 0 |
| 6.7 | 0.771 | 0 | 160 | 0.159 | 130 |
| 7.2 | 0.771 | 0 | 362 | 0.159 | 340 |

15% protein

| | | | | | |
|---|---|---|---|---|---|
| 5.70 | 0.785 | 0.145 | 0 | 0 | 0 |
| 6.2 | 0.785 | 0.047 | 0 | 0.098 | 0 |
| 6.7 | 0.785 | 0 | 60 | 0.145 | 30 |
| 7.2 | 0.785 | 0 | 200 | 0.145 | 150 |

14% protein

| | | | | | |
|---|---|---|---|---|---|
| 5.70 | 0.796 | 0.134 | 0 | 0 | 0 |
| 6.2 | 0.796 | 0.066 | 0 | 0.068 | 0 |
| 6.7 | 0.796 | 0 | 68 | 0.134 | 45 |
| 7.2 | No data | | | | |

Table 16(a) and (b) shows the texture and modified Schreiber melt data of processed cheese slices made at 16, 15 and 14% total protein.

TABLE 16
16(a) Texture

| Texture (N) | Rennet casein | | | Alphaₛ casein fraction | | |
|---|---|---|---|---|---|---|
| Cook pH | 16% | 15% | 14% | 16% | 15% | 14% |
| 5.7 | 5.27 | 3.04 | 1.74 | 5.92 | 4.55 | 2.17 |
| 6.2 | 6.04 | 4.35 | 2.08 | 7.23 | 6.57 | 3.01 |
| 6.7 | 6.61 | 4.35 | 2.25 | 7.14 | 6.63 | 3.26 |
| 7.2 | 6.10 | 3.51 | — | 6.97 | 6.18 | — |

16(b) Modified Schreibet Melt

| Melt | Rennet casein | | | Alphaₛ casein fraction | | |
|---|---|---|---|---|---|---|
| Cook pH | 16% | 15% | 14% | 16% | 15% | 14% |
| 5.7 | 3.4 | 5.6 | 7.9 | 3.0 | 5.0 | 6.3 |
| 6.2 | 5.8 | 4.3 | 6.2 | 2.0 | 2.8 | 4.3 |
| 6.7 | 6.5 | 5.2 | 5.4 | 1.3 | 3.9 | 4.2 |
| 7.2 | 6.3 | 5.7 | — | 0.8 | 4.5 | — |

### Preparation of Sample Partially Denatured WPC

Cheese whey retentate (80% protein) at 8% total solids and a pH of 6.5 was neutralised to pH 7.0 using 2% solution of slaked lime [Ca(OH)₂]. The neutral solution was heated to 120° C. by direct steam injection and held at temperature for 240 s. Then the heat treated mixture was cooled to about 60° C. by passing through a heat exchanger. The cooled mixture was 2-stage homogenised using pressures of approximately 250 bar and 60 bar. The slurry was concentrated using a falling film evaporator to approx. 30% solids and spray dried to a powder with a moisture content of about 4.5%.

### Example 4

Use of the alphaₛ casein fraction and alphaₛ depleted casein fraction (referred to as Beta-casein fraction) in a model yoghurt system

The theoretical composition of the yoghurt is as follows:

| | |
|---|---|
| Protein | 4.0% |
| Fat | 0.1% |
| Ash | 0.8% |
| CHO | 9.8% |
| TS | 14.7% |

The actual formulation for yoghurt in this example was as follows in Table 17:

TABLE 17

| Yoghurt Formulation | % | g for 5 kg |
|---|---|---|
| Water | 84.89 | 4244.5 |
| SSMP | 9.0 | 450 |
| Sugar | 5.0 | 250 |
| Yoghurt texture improver (YTI) | 1.11 | 55.5 |
| blend | | |
| | 100 | 5000 |

where SSMP is spray-dried skim milk powder.

The casein and whey protein blend (80:20 casein: whey) was used as a YTI to replace ˜25% of the protein.

### YTI Formulation:

The Yoghurt Texture Improver (YTI) blend was based on 77% Alanate 180 (Fonterra Co-operative Group Limited at 92.7% protein this equates to 71.4 g protein) and 23% A132 (at 79.3% protein this equates to 18.2 g protein) to give a casein to whey protein ratio of 80:20.

YTI blends prepared using casein fractions (alphaₛ casein and alpha-depleted casein, known as beta-casein fraction) were made so as to have equivalent protein content and casein: y ratio to the sodium caseinate YTI blend.

### Yoghurt Preparation:

SSMP, sugar and caseinate YTI samples were weighed into a plastic bag and mixed together. These dry ingredients were dissolved in hot (˜55° C.) tap water for 30 min.

Casein YTIs were dissolved for 30 min using hot (˜55° C.) tap water and 0.5 M sodium hydroxide (to pH 6.8-7.10 (for addition to SSMP/sugar/water solution later).

The other dry ingredients (SSMP and sugar) were dissolved in the remaining (hot) water for around 20 min.

The dissolved casein solution was added to the SSMP and sugar solution and mixed together for around 5 min.

### Yoghurt Making Process:

The yoghurt milks were homogenised in a 2-stage homogeniser (Rannie, Copenhagen) at 150/50 bar at 55° C., then heated in a steam bath to 85-88° C. and held for 15 mins. They were then cooled quickly in ice to 10° C. and refrigerated until ready to add the culture.

The yoghurt milks were warmed to 42° C. and inoculated with YC-380 culture at 0.0254632 g/L and incubated (as stated below) at 42° C. for 5-6 hrs—until pH was 4.5.

a) For set yoghurt, the inoculated yoghurt milk was poured into 120 g potties and incubated in the pottles. When the yoghurt was at pH 4.5, the potties were removed from the incubator and placed in a fridge to cool.
b) For stirred yoghurt, the inoculated milk was incubated in the beaker (and packed into pottles after cooling and smoothing). After incubation the yoghurts were cooled to 20° C.-25° C. in ice (gently breaking up the coagulum as they cooled).

The yoghurts were smoothed by homogenising (Rannie, Copenhagen) with no pressure.

They were packed into 120 g potties and refrigerated until requited for testing.

Viscosity was measured at 10° C. using a Haake VT500 viscometer (Haake Mess-Technik GmbH u. Co, D-7500 Karlsruhe 41, Germany) and a MV1 coaxial cylinder system. The results are shown in Table 18.

TABLE 18
Results for yoghurt viscosity with different YTI blends

| | Viscosity at 10° C. |
|---|---|
| Casein source in YTI blend | (mPa · s) |
| Beta caseinate fraction | 330 |
| Beta casein fraction | 324 |
| A180 control (Na Caseinate) | 305 |
| A180 control (Na Caseinate) | 314 |
| Lactic casein control | 299 |
| alphaₛ caseinate fraction | 249 |
| alphaₛ casein fraction | 250 |

### Example 5

### Model Processed Cheese Spread Preparation Using MPC 85

The whey protein to total protein ratio was calculated at 20% and the amount of alphaₛ casein fraction to the total protein ratio at 33%.

The recipes for each sample are listed in Tablet. TSC, CA, NaOH and HCl are used for adjusting the cook pH of the processed cheese.

The firmness results are shown in Table 20.

### 5.1 Model Processed Cheese Spread Preparation Using MPC 85 at a Cook pH of 5.7

The model processed cheeses were prepared using a 2 L capacity Vorwerk Thermomix™ 21 blender cooker (Vorwerk Australia Pty. Ltd., Granville, N.S.W., Australia). The recipe is as detailed in Table 19.

Soya oil (186.6 g, AMCO, Blue Bird Foods Ltd, Auckland, New Zealand) was heated for 1 min at temperature scale set at 100° C. and speed set at 1 (this will bring the oil temperature to 60° C.).

The required amount of MPC 85 (70.2 g, MPC 485, Fonterra, New Zealand), lactose (0.2 g, Fonterra, New Zealand), 11.974 g trisodium citrate Jungbunzlauer GmbH, Perhofen, Austria), 3.020 g of citric acid (Jungbunzlauer GmbH, Perhofen, Austria), 6 g sodium chloride (Pacific salt, Christchurch, New Zealand), and water (279.6 g (included 5.4 g water for evaporation)) were added to the oil. The mixture was cooked at a temperature scale of 90° C. for 2 min at speed 4 (2000 rpm), after which the temperature was lowered to a temperature scale of 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. 20 g of water was added at the end of the holding time. The mixture was then cooked for a further 2 min with 3 s “turbo” every minute. The total cooking time was 10 min. The molten processed cheese was poured into plastic screwed cap containers, inverted then stored at 4° C. The final pH of the processed cheese was 5.75.

### 5.2 Model Processed Cheese Spread Preparation Using MPC 85 at a Cook pH of 6.65

The model processed cheeses were prepared using a 2 L capacity Vorwerk Thermomix™ 21 blender cooker (Vorwerk Australia Pty. Ltd., Granville, N.S.W., Australia). The recipe is as detailed in Table 19.

Soya oil (186.6 g, AMCO, Blue Bird Foods Ltd, Auckland, New Zealand) was heated for 1 min at temperature scale set at 100° C. and speed set at 1 (this will bring the oil temperature to 60° C.).

The required amount of MPC 85 (70.2 g, MPC 485, Fonterra, New Zealand), lactose (0.2 g, Fonterra, New Zealand), 11.974 g trisodium citrate Jungbunzlauer GmbH, Perhofen, Austria), 6 g sodium chloride (Pacific salt, Christchurch, New Zealand), and water (279.6 g (included 5.4 g water for evaporation)) were added to the oil. The mixture was cooked at a temperature scale of 90° C. for 2 min at speed 4 (2000 rpm), after which the temperature was lowered to a temperature scale of 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. Citric acid (3.020 g, Jungbunzlauer GmbH, Perhofen, Austria) dissolved in 20 g of water was added at the end of the holding time. The mixture was then cooked for a further 2 min. with 3 s “turbo” every minute. The total cooking time was 10 min. The molten processed cheese was poured into plastic screwed cap containers, inverted then stored at 4° C. The final pH of the processed cheese was 5.75.

### 5.3 Model Processed Cheese Spread Preparation Using a Mixture of MPC 85 and Alphaₛ Casein Fraction at a Cook pH of 5.7

The model processed cheeses were prepared using a 2 L capacity Vorwerk Thermomix™ 21 blender cooker (Vorwerk Australia Pty. Ltd., Granville, N.S.W., Australia). The recipe is as detailed in Table 19.

Soya oil (187.11 g, AMCO, Blue Bird Foods Ltd, Auckland, New Zealand) was heated for 1 min at temperature scale set at 100° C. and speed set at 1 (this will bring the oil temperature to 60° C.).

The required amount of MPC 85 (47.5 g, MPC 485, Fonterra, New Zealand), alpha, casein fraction (30 mesh all in (“all in” means that it includes all powder particles less than 600 μm in diameter), Fonterra Innovation pilot plant, Palmerston North), lactose (1.25 g, Fonterra, New Zealand), trisodium citrate (13.229, Jungbunzlauer GmbH, Perhofen, Austria), citric acid (1.764 g, Jungbunzlauer GmbH, Perhofen, Austria), sodium chloride (6 g, Pacific salt, Christchurch, New Zealand), WPC (1.44 g, ALACEN 392, Fonterra, New Zealand) and water (279.9 g (included 5.4 g of water for evaporation)) were added to the oil. The mixture was cooked at a temperature scale of 90° C. for 2 min at speed 4 (2000 rpm), after which the temperature was lowered to a temperature scale of 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. 20 g of water was added at the end of the holding time. The mixture was then cooked for a further 2 min with 3 s “turbo” every minute. The total cooking time was 10 min. The molten processed cheese was poured into plastic screwed cap containers, inverted then stored at 4° C. The final pH of the processed cheese was 5.75.

### Model Processed Cheese Spread Preparation Using a Mixture of MPG 85 and Alphaₛ Casein Fraction at a Cook pH of 6.65

The model processed cheeses were prepared using a 2 L capacity Vorwerk Thermomix™ 21 blender cooker (Vorwerk Australia Pty. Ltd., Granville, N.S.W., Australia). The recipe is as detailed in Table 19.

Soya oil (187.11 g, AMCO, Blue Bird Foods Ltd, Auckland, New Zealand) was heated for 1 min at temperature scale set at 100° C. and speed set at 1 (this will bring the oil temperature to 60° C.).

The required amount of MPC 85 (187.11 g, MPC 485, Fonterra, New Zealand), alpha, casein fraction (30 mesh all in (“all in” means that it includes all powder particles less than 600 μm in diameter), Fonterra Innovation pilot plant, Palmerston North), lactose (1.25 g, Fonterra, New Zealand), trisodium citrate (13.229 g, Jungbunzlauer GmbH, Perhofen, Austria), 1.56 mL of 3M NaOH, sodium chloride (6 g, Pacific salt, Christchurch, New Zealand), WPC (ALACEN 392, Fonterra, New Zealand) and water (276.6 g (included 5.4 g of water for evaporation)) were added to the oil. The mixture was cooked at a temperature scale of 90° C. for 2 min at speed 4 (2000 rpm), after which the temperature was lowered to a temperature scale of 80° C. for a holding time of 5 min. At the end of each minute, the speed was set to “Turbo” (12000 rpm) for 3 s to thoroughly mix the emulsion as well as to prevent burning and sticking of the emulsion to the wall of the cooker. 1.764 g citric acid Jungbunzlauer GmbH, Perhofen, Austria) dissolved in 20 g of water and 1.66 mL of 3M HCl were added at the end of the holding time. The mixture was then cooked for a further 2 Mill with 3 s “turbo” every minute. The total cooking time was 10 min. The molten processed cheese was poured into plastic screwed cap containers, inverted then stored at 4° C. The final pH of the processed cheese was 5.75.

Note: The water associated with the added NaOH and HCl was subtracted from the added water to obtain the required moisture content of the processed cheese.

### Composition of the Model Processed Cheese

All the processed cheeses had been formulated to contain 52.0% moisture, 32.8% fat, 10.0% protein, 0.6% lactose and remainder 4.6% minerals and others. The firmness of the samples is shown in Table 20.

TABLE 19
Recipe for model processed cheese spreads made using
MPC 85 and alphaₛ casein fraction.

| Ingredients | MPC 85 (g) | | MPC 85 + alphaₛ fraction (g) | |
|---|---|---|---|---|
| Soya oil | 186.6 | | 187.11 | |
| MPC 85 | 70.2 | | 47.5 | |
| Alphaₛ casein fraction | 0 | | 19.4 | |
| ALACEN 392 | 0 | | 1.44 | |
| Lactose | 0.2 | | 1.25 | |
| Water | 299.6 | | 299.9 | |
| Sodium chloride | 6.0 | | 6.0 | |
| Trisodium citrate | 11.97 | | 13.23 | |
| Citric acid | 3.02 | | 1.76 | |
| 3M NaOH | 0 | | 1.56 | mL* |
| 3M HCl | 0 | | 1.66 | mL* |
| Total | 577.59 | (g) | 577.59 | (g) |

Note:
weight of water includes allowance of 5.4 g for evaporation
*Only for cook pH 6.65 sample, 3.3 g of water was then subtracted from the water added to compensate for the amount of water associated in the acid and base.

### Firmness Measurement

The firmness of the samples was obtained using a TA AR2000 rheometer (AlphaTech, Auckland) at 20° C. with a 2 cm diameter steel plate. The height of the sample was set at 2 mm. The edge of the sample was coated with a light paraffin oil to prevent the sample from drying out. The samples were swept from 10 Hz to 0.01 Hz at a strain 0.005. The firmness reading was taken as the G′ at 0.1 Hz at 20° C.

TABLE 20
Firmness (G′) of model processed cheese spreads
containing MPC 85 and alphaₛ
casein fraction at 20% whey protein to total protein.

| | | MPC85 + |
|---|---|---|
| | | Alphaₛ casein |
| | MPC 85 | fraction |
| pH | (Pa) | (Pa) |
| 5.7 | 62.90 | 630.30 |
| 6.65 | 337.95 | 777.85 |

The above examples are illustrations of the practice of the invention. It will be appreciated by those skilled in the art that the invention to be carried out numerous modifications and variations. For example, the casein/whey protein ratio, the fat content and composition, the cooking temperature, the cooking pH and the acid used to alter the pH may all be varied.

1. A method for preparing a protein gel or a dairy protein gel ingredient, comprising:
(a) providing a dairy starting material comprising casein;
(b) adjusting the pH, if required, to a pre-selected point in the range 5.0-8.0;
(c) subjecting the material with the pre-selected pH to a cooking step;
(d) adjusting the pH of the cooked product to 3.8-7.5;
(e) processing and/or packing the pH 3.8-7.5 product to form the final product or ingredient
wherein at least 10% of the casein of the dairy starting material comprises alphaₛ enriched casein having an alpha, to beta casein weight ratio of greater than 1.25:1 or alpha, depleted casein having an alpha, to beta casein weight ratio of less than 0.8:1.

2. A method as claimed in claim 1 wherein the method has no whey removal step.

3. A method as claimed in claim 1 wherein the protein gel is a cheese, a processed cheese, a cream cheese, a cheese-like product, a yoghurt or a dairy dessert.

4. A method as claimed in claim 1 wherein the dairy starting material is selected from the group consisting of cheese, rennet casein, lactic or acid casein, skim milk, whole milk, milk protein concentrates and mixtures of any of these.

5. A method as claimed in claim 1 wherein the dairy starting material comprises whey protein.

6. A method as claimed in claim 5 wherein the dairy starting material comprises undenatured whey protein.

7. A method as claimed in claim 1 wherein the dairy starting material comprises a mixture of a casein source and a whey protein source.

8. A method as claimed in claim 7 wherein the dairy starting material comprises a mixture of whey protein concentrate and casein.

9. A method as claimed in claim 1 wherein the dairy starting material comprises alpha, enriched casein and the product is a cheese, a cheese-like product or a cream cheese.

10. A method as claimed in claim 1 wherein at least 15% of the casein in the starting material is alpha, enriched casein or alpha, depleted casein.

11. A method as claimed in claim 1 wherein the ratio of whey protein to casein is within the range of 0.05:1 to 3:1.

12. A method as claimed in claim 1 wherein the casein concentration is in the range 3-20% (w/w).

13. A method for preparing a cheese, a cheese-like product, or a dairy dessert comprising:
(a) providing a dairy starting material comprising casein;
(b) adjusting the pH, if required, to a pre-selected point in the range 5.0-8.0;
(c) subjecting the material with the pre-selected pH to a cooking step;
(d) adjusting the pH of the cooked product to 4.5-7.5 while liquid;
(e) placing the pH 4.5-7.5 product into packaging while still liquid; and
(f) providing conditions which allow the packaged product to set;
wherein at least 10% of the casein comprises alphaₛ enriched casein.

14. A method as claimed in claim 1 wherein the alpha, enriched or depleted casein fraction provides 10-50% of the casein in the product.

15. A method as claimed in claim 13 wherein the alpha, enriched or depleted casein fraction provides 15-40% of the casein in the product.

16. A method as claimed in claim 1 wherein the material to be cooked has a pH in the range 5.7-7.5.

17. A method as claimed in claim 15 wherein the pH range is 6.2-7.2.

18. A method as claimed in claim 1 wherein the pH is adjusted to 4.5-6.2 after cooking.

19. A method as claimed in claim 17 wherein the pH is pH 6.1-6.7 before cooking and adjusted to pH 4.8-5.9 after cooking and the protein gel is a cheese slice with alphaₛ casein enrichment.

20. A method as claimed in claim 1 wherein the cooking temperature is in the range 50° C. and up to the boiling point of the mixture, and the cooking time is in the range 1 second to 30 minutes.

21. A method for making a dairy ingredient comprising:
(a) providing a dairy starting material comprising casein and undenatured whey protein;
(b) adjusting the pH, if required, to a pre-selected point in the range 5.0-8.0;
(c) subjecting the material with the pre-selected pH to a cooking step; and
(d) drying the heat treated material to form a powder;
wherein at least 10% of the casein of the dairy starting material comprises alphaₛ enriched casein having an alphaₛ to beta casein weight ratio of greater than 1.25:1 or alphaₐ depleted casein having an alphaₛ to beta casein weight ratio of less than 0.8:1.

22. A method as claimed in claim 1, wherein at least 15% of the casein in the starting material is alphaₛ enriched casein or alpha, depleted casein.

23. A method as claimed in claim 1, wherein at least 20% of the casein in the starting material is alphaₛ enriched.

24. A method as claimed in claim 1, wherein alphaₛ depleted casein is used and has an alpha:beta ratio lower than 0.8:1.

25. A method as claimed in claim 1, wherein the ratio alpha:beta is higher than 3:1.
